(19) United States
(12) Patent Application Publication
(10) Pub. No.: US 2022/0016519 A1
(43) Pub. Date: Jan. 20, 2022

(54) APPARATUS AND METHOD

(71) Applicant: Holovis International Limited, Leicestershire (GB)

(72) Inventors: Johannus Henricus Derek Van Der Steen, Leicester Leicestershire (GB); Stuart Thomas Owen Edgington, Wolston Warwickshire (GB); Peter Cliff, Lutterwurth Leicestershire (GB); Stuart Andrew Hetherington, Yelvertoft (GB)

(21) Appl. No.: 17/297,644

(22) PCT Filed: Nov. 28, 2019
(86) PCT No.: PCT/GB2019/053360

§ 371 Date: May 27, 2021

(30) Foreign Application Priority Data
Nov. 29, 2018 (GB) 1819429.0

(51) Int. Cl. A63F 13/212; G06K 9/00; G06F 3/01; A63F 13/35; A63F 13/73; A63F 13/75; A63F 13/79

(52) U.S. Cl. CPC A63F 13/212; G06K 9/00926; G06F 3/017; G06F 3/013; A63F 13/35; A63F 2300/5586; A63F 13/75; A63F 13/79; A63F 2300/1012; A63F 2300/5546; A63F 13/73

(57) ABSTRACT

Apparatus and method for personalising participation in an activity comprising a plurality of user nodes, each user node including a sensor array serving to generate data in relation to a user at the node and a data processing device for receiving the generated data from the sensor array as to the user, the apparatus further comprising a computer system in communication with the sensor array in each node. This ensures a fluent and immediate personalised experience across the different user nodes.

This invention relates to a system for biometrically detecting a user's experience in an environment and, based upon the detected experience, tailoring subsequent actions.

According to a first aspect of the present invention, there is provided apparatus for personalising participation in an activity comprising a plurality of user nodes, each user node including a sensor array serving to generate data in relation to a user at the node and a data processing device for receiving the generated data from the sensor array as to the user, the apparatus further comprising a computer system in communication with the sensor array in each node.

According to a second aspect of the present invention, there is provided a method of personalising participation in an activity comprising generating data by way of a sensor array in relation a user participating in an activity at one of a plurality of user nodes, communicating the generated data to a computer system configured to drive participation in the activity thereby providing the user with a personalised experience across each node and based upon the generated data at each node.

Owing to these aspects, an interactive experience within an environment can be achieved by a user across different nodes in that environment.

The sensor array may take many forms and may be configured so as to detect both a characteristic of the user at one of the nodes for tracking purposes and also allow the user to participate in and interact with the software-driven activity. This generates tracking and interaction data. It may take the form of an ensemble sensor array.

Advantageously, the characteristic to be detected at each node is a biometric characteristic, wherein the detection device is preferably a facial recognition sensor.

Preferably, the computer system is a software environment, such as a games engine.

Preferably, another software environment in the form of a user interaction analytics engine can also be provided.

Advantageously, in order to provide the user with a fluent and immediate personalised experience across the different user nodes, artificial intelligence (AI) biometrics engines are utilised. The biometrics engines are the core programs controlling a whole biometric system. This includes the extraction of biometric data during enrolment, the extraction of distinguishing features from the collected biometric data, and the matching and authentication stages. The biometrics engines improve data quality and combine multiple data sensor sets to improve the functional result. Thus, the data becomes easy to match whenever a user needs to be authenticated. In this way, the biometrics engines will help handle user data in order to reduce false positives and impersonator access.

A control system may also be included and configured to drive participation in an activity and providing the user with a personalised experience across each node, based upon a detected characteristic at each node by way of the sensor array.

In order that the present invention can be clearly and completely disclosed, reference will now be made, by way of example only, to the accompanying drawings in which:—

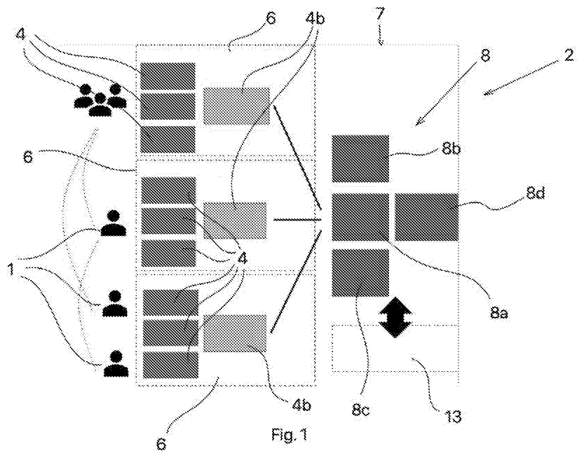

FIG. 1 is a simplified schematic diagram of the system of the present invention in node-form,

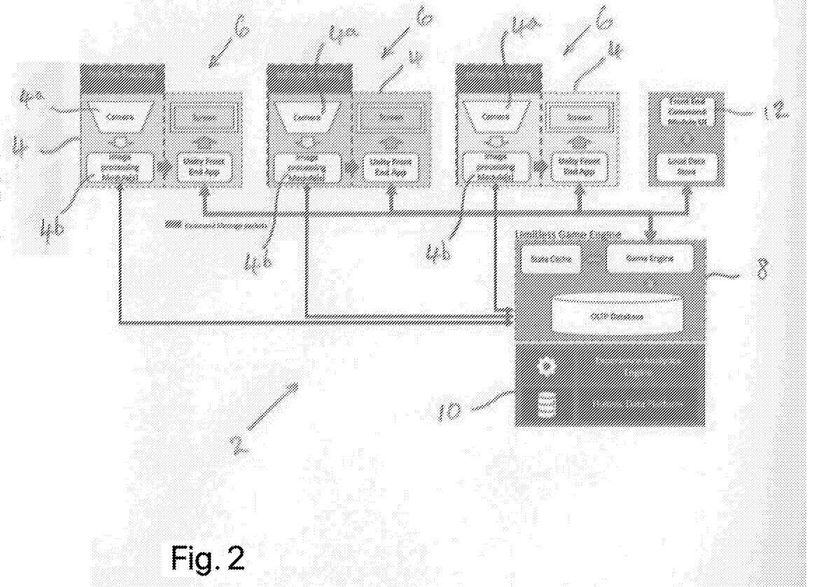

FIG. 2 is a schematic diagram of a system for an interactive experience within an theme park environment, across different zones in that theme park,

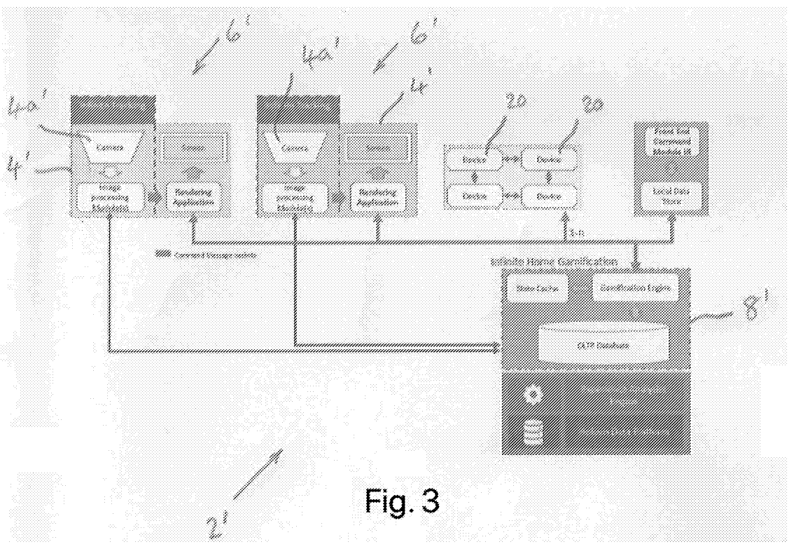

FIG. 3 is a diagram similar to FIG. 2 but of a similar system applied to an assisted living situation,

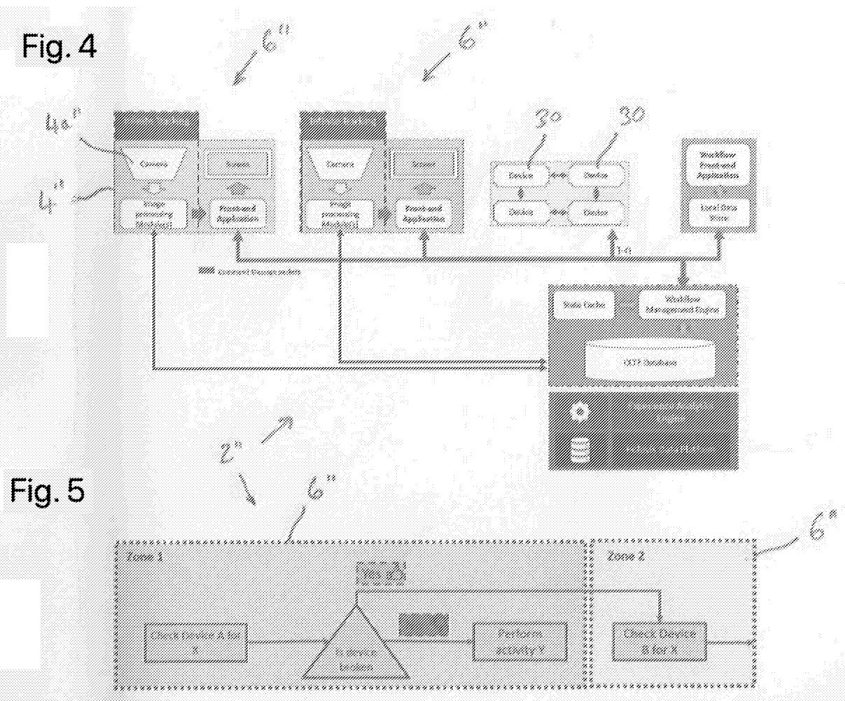

FIG. 4 is a diagram similar to FIGS. 2 and 3 but of a similar system applied to work place, and

FIG. 5 is a diagram showing a workflow management application of the system of FIG. 4.

Referring to FIG. 1, a simplified nodal schematic of a system 2 is shown in which one or more users 1 are present at first nodal positions 6, which are at different physical locations. Each of the first nodal positions 6 comprise an ensemble sensor array 4 to enable the identification of individual users 1, the output of the sensors of the array 4 at each first nodal position 6 being communicated to a data processing device 4b at each first nodal position 6. At a second nodal position 7, the data from the data processing device 4b is communicated to a computer system 8, which may include one or more of a server computer 8a, a games engine 8b, a data store 8c and an analytics engine 8d. External systems 13 may be connectable with the hardware at the second nodal position 7.

Referring to FIG. 2, one application of the present invention relates to entertainment of a user involved in an interactive narrative activity that is located across a plurality of zones or sites in an environment such as a theme park, and incorporates sensor analysis of the user. The system 2 comprises the ensemble sensor array 4 in each of a plurality of first nodes 6. Each ensemble sensor array 4 is configured to identify the user and understand multiple aspects of a guest's interactive experience to generate data in relation to the user. The ensemble sensor array 4 may comprise, for example, a sensor 4a in the form of a facial recognition sensor, which may be a camera. The facial recognition sensor is coupled with a data processing device (a distributed state machine) 4b being driven by the first computer system 8, and in particular the games engine 8b. Ancillary sensors (not shown) may also be present at each first node 6 and may involve devices for object recognition, gesture recognition, motion tracking, or for eye tracking or other user variables. The system 2 provides the user a fluent and immediate personalised experience across the different first nodes 6 or locations, with no need to sign in and use login credentials at each zone. This area of the interaction is fulfilled by artificial intelligence (AI) biometrics engines, which take the form of machine learning algorithmic processes (such as facial identification and tracking using computer vision, being one example) that generate biometric/neurophysiological data as input data which is then processed and interpreted in order to produce some useful effect, e.g. identifying the user and tracking their progress in a game scenario.

The system 2 also comprises a control system 12 which can include the external systems 13 mentioned hereinabove, which may be implemented as a computer in communication with the first computer system 8 and thus the ensemble sensor array 4. The control system 12 can be configured to either run automatically as a dynamic storyline narrative that iterates based on how the user is interacting with the activity in real time or manually to drive specific content and storyline progression dependent on manual intervention and guidance. For example, in the automatic instance, dependent on how the user interacts within the storyline narrative and based on the decisions that they have taken they will have a tailored narrative that can be modelled to adapt to specific criteria as dictated within the original configuration. Alternatively, the control system is also designed to allow for a manual intervention if an operator wants to push a user narrative into a different path or set of events and interactions. A front-end command module 15 in the external systems 13 is present at park administration level and includes a configuration application which allows operators to adapt the system in real-time and monitor performance and usage.

Each first node 6 includes a point of user identification which may include, but is not limited to, the sensor 4 connected to a data processing device for identification and tracking purposes. The ensemble sensor array 4 may also include a screen 4c or other interactive unit, such as a projection-mapped object with which the user is able to perform some interaction. The games engine 8b is based on a state-machine logic, which, in a basic form, can be portrayed as a decision tree matrix, where at each event in the activity there is the possibility of the user choosing to go to any of the additional nodes 6.

The data store 8c allows the consumption of data either directly from sensor sources or via an application or web service layer. The data store supports the storage and processing of data and the creation and maintenance of data assets (data models, tables, key-value stores, views, multidimensional cubes, etc.) and client specific configurations. The data store 8c also enables the provision of data products (visualisations, reports, extracts, models, etc.) across multiple access points including browser-based portals, business system integrations, descriptive/predictive/prescriptive model outputs and automated self-serving reporting.

An interaction analytics engine 8d provides an advanced data science and analytics environment that can be configured to track user interactions at the different nodes 6 through which valuable information regarding user behaviour can be obtained. In this way, the interaction analytics engine delivers real-time descriptive, prescriptive and predictive outputs. It can be used to develop predictions, classification, recommendation engines, optimisation models and forecasting.

Use of the system of FIG. 2 allows for passive identification of guests across the plurality of nodes 6, the use of an array of sensors enabling accurate and robust tracking. This allows enhanced computer vision and depth perception, the use of other sensor types such as Bluetooth and RFID tags, together with the integration with non-linear storyline-narrative built on the state-machine engine allowing guests to choose how they engage with the storyline, and the manual intervention of a dynamic storyline narrative through park control operation. In addition, through adapting meta-game instructions to users, the system allows the ability to channel guests to different areas of the theme park and data harvested from the interaction analytics engine 16 allows park management to understand aspects like, but not limited to, crowd dynamics and movements.

In practice, a user-led journey in a theme park may take the following form:—
1. A guest arrives at the theme park and enters into a registration zone and becomes a user whereupon a sensor array passively logs the user into a game database
2. Upon registration, the user is entered into a storyline narrative and set on a game “quest” or task to, for instance, find an item or series of items
3. The user interacts by way of the user interface with any of the plurality of nodes 6 in any order. Depending on their selection and the history of their interaction in the nodes 6 in the park, particular media content will be displayed to the user on a screen
4. The user continues their task, and any supplementary tasks throughout their time within the theme park
5. The game state logic and accompanying database are able to remember a user's history within the theme park

Referring to FIG. 3, a further version of the system 2′ is shown combined with a tracking model that records users' behaviours against predefined criteria. One practical application of this model could be focussed around assisted living and tracking a user's activities in relation, for example, to taking their medication and promoting an active lifestyle to better their personal health and overall wellness. As with the model in FIG. 2, the ensemble sensor array 4′ includes the sensor 4a′ which revolves around facial recognition but, preferably coupled with a software application and a rendering engine to showcase the visualisations. Ancillary sensors (not shown) within the ensemble sensor array 4′ may involve object recognition, gesture recognition, motion tracking, geometric or other sensor types. The system 2′ is designed to communicate with so-called smart devices 20, such as smart dispensers in order to log information such as medicinal intake and also additional applications, for example, multiple interconnected devices within a “smart” home including laptops, TVs and refrigerators, speakers and other smart appliances.

The system 2′ can use gamification models driven by the games engine 8b′ to promote healthy living. By using the sensor array of the ensemble sensor array 4′, the system 2′ is able to understand variables about a user's behaviour, including but not limited to, sleeping, eating and exercising. These states are tracked and applied against defined criteria to understand how a user is performing, this being configured within the front-end command module 15′. The command module 15′ allows a user to create a profile of predefined activities that need to occur within a defined timeframe. This is able to be configured to apply a gamification model that assigns, for example, a value to activities to derive a score. For example, in the case where the user is meant to be exercising every morning for 15 minutes, the system 2′ will track this activity at any of the plurality of nodes 6′ using spatial tracking sensor(s) tracking a computer-generated exoskeleton of the user and reward points in a gamification-based model for successful instances of this activity. This information is captured and stored and made available through various visualisation types to authorised parties, such as medical professionals and the like. If the user does not complete the prescribed exercise within the given timeframe, this information is also tracked and stored and made available to authorised parties. By using various gamification techniques, the user can be incentivised to perform an action. The activities are tracked across different nodes 6′ in a property, with no need to sign in and use login credentials. This area of the interaction is fulfilled by the AI biometrics engines.

In practice, this model may take the form of the following steps:—
1. The user wakes up in the morning in a bedroom, which is one of the nodes 6′. The system has already logged the quality of their sleep using biometric sensors located within the ensemble sensor array 4′. This information is captured for future review.
2. The user approaches a screen in another of the plurality of nodes 6′ in the form of a different room, the system 2′ being activated automatically in that different node 6′ and displays the user's morning exercise routine and the day's schedule including medication requirements on the screen.
3. After performing the exercise activity, the system awards positive points within the gamification model.
4. The user goes to another different node 6′ in the form of another room where a medicine cabinet is located. The system 2′ is, again, activated automatically and records the user's medicinal intake by communicating with a “smart” dispenser application of a dispensing device 20 which contains the required medication of the user.
5. The user's score is displayed and tracked for authorised personnel along with relevant data as per the configuration outlined within the command module.

Spatial tracking using a computer-generated exoskeleton can detect if the user's hand which may have, for example, a tablet or pill in it reaches the user's mouth in order to meet a functional need of the system 2′.

Referring to FIG. 4, a third application of the system 2″ is combined with a workflow management interface and application. One practical application of this system 2″ is within industries where the need for procedural activities in a particular combination is required but where physically interfacing with devices is challenging. The sensor 4a″, again, revolves around facial recognition but coupled with a software application embedded with a workflow management system that showcases a user's progress in a particular activity or job. Ancillary sensors (not shown) may include object recognition, gesture recognition, auditory, motion tracking, geometric or other sensors. The system is configured to integrate with existing enterprise applications such as customer relationship management (CRM) or enterprise resource planning (ERP) implementations through a web API.

This workflow management system is, advantageously, designed as a configurable drag and drop interface that allows the process owner to design and develop live workflows for specific tasks, and to be able to tag instances within a workflow process against specific nodes 6″ with additional connected devices 30 or interactions.

Ultimately this system allows the individual user to have a clear set of activities and instructions that they need to perform to complete a task within a certain timeframe, and at each stage, the activity being monitored and recorded.

The system is arranged to identify that the correct user has arrived at the correct node 6″ to perform a set activity. This is performed through user roles configured within the system and tagged against a user's facial profile.

There is, again, in this system passive identification of the user across multiple nodes 6″, and use of an array of sensors to create accurate and robust tracking. In a similar manner to that of the system of FIG. 2, the data is made available for review from authorised parties.

FIG. 5 shows a manifestation of the system of FIG. 4 integrated within a workflow management application. The user initially arrives at one of the nodes 6″ where the system 2″ is able to identify that the correct user has arrived to perform the activity and launches the workflow management application. The workflow management system then prompts the user to check a device A for a specific issue, fault, or general check. The user checks device A as prompted and the system asks if the device is broken. The user makes a gesture movement detected by a gesture recognition sensor, so as to give, for example, a thumbs up or thumbs down depending on the status of device A. If an affirmative gesture is given by the user to indicate that device A is broken, the system indicates to the user to proceed to a different node 6″ to perform another action. If, however, the gesture from the user indicates that device A is operational and thus not broken, a different instruction is given to the user to perform a different activity at a further different node 6″.

1. Apparatus for personalizing participation in an activity comprising a plurality of user nodes, each user node including a sensor array serving to generate data in relation to a user at the node and a data processing device for receiving the generated data from the sensor array as to the user, the apparatus further comprising a computer system in communication with the sensor array in each node.

2. Apparatus according to claim 1, wherein the sensor array is configured so as to detect both a characteristic of the user at one of the nodes for tracking purposes and also allow the user to participate in and interact with a software-driven activity.

3. Apparatus according to claim 1, wherein the data in relation to the user is a user biometric characteristic to be detected at each node.

4. (canceled)

5. Apparatus according to claim 4, and further comprising another software environment in the form of a user interaction analytics engine.

6. Apparatus according to claim 3, and further comprising a control system configured to drive participation in the activity and providing the user with a personalized experience across each node, based upon the detected characteristic at each node by way of the sensor array.

7. Apparatus according to claim 1, and further comprising artificial intelligence (AI) biometrics engines controlling a biometric system.

8. Apparatus according to claim 1, wherein the activity is entertainment of a user involved in an interactive narrative activity that is located across a plurality of zones in a theme park environment.

9. Apparatus according to claim 1, wherein the sensor array comprises devices for object recognition, gesture recognition, motion tracking, or for eye tracking.

10. Apparatus according to claim 1, and further comprising a tracking model that records the user's behavior against predefined criteria.

11. (canceled)

12. Apparatus according to claim 1, the activity being one monitored by a workflow management interface.

13. (canceled)

14. A method of personalizing participation in an activity comprising generating data by way of a sensor array in relation a user participating in an activity at one of a plurality of user nodes, communicating the generated data to a computer system configured to drive participation in the activity thereby providing the user with a personalized experience across each node and based upon the generated data at each node.

15. A method according to claim 14, wherein the sensor array is configured so as to both detect a characteristic of the user at one of the nodes for tracking purposes and also allow the user to participate in and interact with a software-driven activity.

16. A method according to claim 15, and further comprising providing the user with a personalized experience across each node, based upon the detected characteristic at each node by way of the sensor array.

17. (canceled)

18. A method according to claim 17, wherein the biometrics engines extract biometric data during an enrollment process, extract distinguishing features from the collected biometric data, and in matching and authentication stages to reduce false positives and impersonator access.

19. A method according to claim 14, wherein the activity is entertainment of a user involved in an interactive narrative activity that is located across a plurality of zones in a theme park environment.

20. A method according to claim 19, and comprising the following steps:
(a) entering an enrollment zone and becoming a registered user whereupon the sensor array passively logs the user into a game database,
(b) the user is entered into a storyline narrative and set on a game task interacting by way of a user interface with any of the plurality of nodes in any order,
(c) displaying particular media content to the user on a screen,
(d) continuing the task, and any supplementary tasks, and
(e) storing the user's history within the theme park.

21. A method according to claim 14, and further comprising a tracking model that records the user's behavior against predefined criteria.

22. A method according to claim 21, and further comprising artificial intelligence (AI) biometrics engines controlling a biometric system the method including the following steps:
(a) the user waking up in the morning in a bedroom, which is one of the nodes, the system having already logged quality of sleep using biometric sensors,
(b) the user approaching a screen in another of the plurality of nodes in the form of a different room, an automatically activating a display of the user's schedule,
(c) performing a timely activity according to the user's schedule, and
(d) tracking the performing for authorized personnel.

23. (canceled)

24. A method according to claim 14, the activity being one monitored by a workflow management interface.

25. A method according to claim 24, and comprising the following steps:
(a) the user initially arrives at one of the nodes to identify that the correct user has arrived to perform the activity and launch a workflow management application,
(b) the workflow management application then prompting the user to check an item,
(c) the user checks the item as prompted and the workflow management application asks if the item is faulty,
(d) the user making a gesture movement detected by a gesture recognition sensor in the sensor array to indicate the status of the item,
(e) in the event of an affirmative gesture being given, the workflow management application indicates to the user to proceed to a different node to perform another activity, or in the event of a negative gesture, a different instruction is given to the user to perform a different activity at a further different node.
